(19) United States
(12) Patent Application Publication
(10) Pub. No.: US 2005/0235248 A1
(43) Pub. Date: Oct. 20, 2005

(54) Apparatus for discovering computing services architecture an developing patterns of computing services and method therefor

(75) Inventors: Emarson Victoria, Singapore (SG); Hui Ming Jason, Singapore (SG); Hwee Hwa Pang, Singapore (SG); Tau Chen Cham, Singapore (SG); Siew Choo Tay, Singapore (SG)

Correspondence Address: CONLEY ROSE, P.C., P. O. BOX 3267, HOUSTON, TX, 77253-3267, US

(73) Assignee: Agency for Science, Technology and Research, Singapore (SG)

(21) Appl. No.: 10/514,705

(22) PCT Filed: May 16, 2003
(86) PCT No.: PCT/SG03/00113

§ 371 Date: Jun. 2, 2005

(30) Foreign Application Priority Data
May 16, 2002 (SG) SG/02/00095
Jun. 3, 2002 (SG) SG/02/00110

(51) Int. Cl. G06F 9/44

(52) U.S. Cl. 717/102; 717/107

(57) ABSTRACT

An apparatus for discovering computing services architecture and developing patterns of computing services and method therefor are disclosed. The apparatus, according to an embodiment of the invention, provides a graphical user interface for displaying a deployment plan of deployed computing services. Components in the deployment plan are interconnected by links indicating dependency relationships between the components. Each component and link is assigned a confidence value, which is based on a calculated weight of the properties of each component. The apparatus further provides editing tools for manipulating the components in the deployment plan as well as for creating and managing patterns.

### FIELD OF THE INVENTION

This invention relates to a computing system deployment system. In particular, it relates to an apparatus for discovering computing services architecture and developing patterns of computing services and method therefor.

### BACKGROUND

Conventional computing systems, for example enterprise applications, typically possess multi-tier and distributed architectures. Unlike standalone applications in the past, these enterprise applications provide specialized solutions catering to different business needs within organizations or across geographically distant installations. The elaborate structure of these enterprise applications gives rise to a vast quantity of heterogeneous enterprise back-end computing.

Management of the enterprise applications to maintain architectural integrity and performance of the enterprise applications is critical for creating new applications and for providing availability of business services to users.

The aspects of the computing systems typically requiring management includes the deployment and configuration of computing system services, system functionality diagnosis, maintaining the integrity of the component dependencies within a computing system, and monitoring and balancing of computing system component loading for improving computing system performance.

In the course of managing the computing systems, a situation requiring components of an application to be moved between two systems at different locations may arise. Alternatively, new resources may be made available to the system that the enterprise applications reside within. In both these situations, there is a need to reconfigure a previously configured system. In most cases, the deployment of an application or its components requires complicated procedures that requires specialized training in the application being installed as system integrity has to be preserved at all times.

A computing system typically undergoes several configuration changes and a few revisions of its associated components in the course of its life. Once an application is deployed within a system and becomes operational, it will undergo further component replacements, enhancements and expansion in scale. Thus, keeping the dependencies and the integrity of large-scale systems becomes problematic as possibly, different vendors provide different applications. Typically, maintaining the computing systems needs to be performed by an administrator who is deploying the computing systems or applications. In such a situation, the dependencies and inter-connection requirements between computing systems are provided to the administrator in the form of instructional manuals. Further knowledge of the requirements and limitations of each system, application or its components is dependant on the experience and tacit capability of the administrator.

Therefore, it is desirable to have a common framework and method for capturing or specifying all these information in a structured manner, so that the dependency calculations can be automated.

A computing system deployment method addresses the foregoing issues by introducing layers and clusters for segregating computing system, system and resource components based on their functionality and services provided thereby. Associations between components are registered in profiles to facilitate dependency tracking. The computing system deployment method allows for structured deployment of the computing system onto a first host system. The profiles further facilitate migration of the computing system and its associated components onto a second host system without compromising system integrity.

Existing infrastructures can benefit from the computing system deployment method once information relating to the deployed computing services is known. A computing services architecture discovery method based on the computing system deployment method provides steps for discovering deployed computing services to facilitate infrastructure re-architecting, re-alignment processes and optimization.

Existing reverse engineering and software exploration methods and tools are typically domain specific and largely relate to software maintenance and engineering, database reverse engineering and object-oriented design patterns and recovery for recovering software-coding patterns at source-level. Examples of these methods and tools include PLASTIC by Plastic Software, which provides documentation and annotation capabilities once a pattern of the deployed computing services is discovered. Jbuilder and TogetherSoft are Integrated Development Environment (IDE) tools. These IDE tools provide two-way process in which discovered patterns can be modified and the corresponding source codes are automatically changed and vice versa. Another example is Microsoft Visio by Microsoft, which can construct an object model of a database when the connection information for the database is provided. However, it does not allow any modification to be made to the database schema unless the database is supported by the Visio product.

Other such methods and tools are for website and web applications architecture recovery and network topology designing. Examples of these methods and tools include Adobe GoLive and Network Sonar. The Adobe GoLive can construct a graphical diagram of the website development based on the web-page repositories by traversing through the link elements found in the web-pages and construct the diagram. The Network Sonar can construct topology diagrams, network connectivity diagrams from existing network by employing probing techniques such as SNMP and ICMP.

These methods and tools do not provide information on how each component (e.g. web-servers and applications servers) inter-operates with each other, its dependencies and configuration, which are essential information to aid in the understanding of the existing infrastructure as a whole and planning for new deployments or migration. Discovered service architectures and patterns are not readily modified and fine-tuned due to the lack of proper tools and framework for storing information relating to the deployed components. Further, discovered patterns that represent best practices and bad practices cannot be archived for future references. Thus, future system deployment designs cannot be leveraged from the knowledge of past experiences due to the lack of such archives.

Clearly, there is a need for an apparatus for discovering computing services architecture and developing patterns of computing services and method therefor, wherein tools are provided for fine-tuning the discovered computing services architecture and abstracting pats therefrom and archiving the patterns for future references.

### SUMMARY

An apparatus for discovering computing services architecture and developing patterns of computing services and method therefor are disclosed. The apparatus, according to an embodiment of the invention, provides a graphical user interface for displaying a deployment plan of deployed computing services. Components in the deployment plan are interconnected by links indicating dependency relationships between the components. Bach component and link is assigned a confidence value, which is based on a calculated weight of the properties of each component The apparatus fryer provides editing tools for manipulating the components in the deployment plan as well as for creating and managing patterns.

Therefore, in accordance with a first aspect of the invention, there is disclosed an apparatus for discovering computing services architecture and developing patterns of computing services, the apparatus comprising:
a component profile repository for containing component profiles of a computing service, each component profile being associated with and being descriptive of a corresponding deployable component, at least one of the component profiles being associated wit a corresponding deployed component of the computing service, the deployed component being one of predefined and undefined;
a computing service deployment plan, the computing service deployment plan being constructed based on information contained in the component profiles of the computing service; and
a discovering tool for manipulating the computing service deployment plan,
whereby when the deployed component is undefined and therefore undiscovered, the deployed component is discoverable by the apparatus for constructing the computing service deployment plan.

In accordance with a second aspect of the invention, there is disclosed a method of discovering computing services architecture and developing patterns of computing services, the method comprising the steps of:
A method of discovering computing services architecture and developing patterns of computing services, the method comprising the steps of:
providing a component profile repository for containing component profiles of a computing service, each component profile being associated with and being descriptive of a corresponding deployable component at least one of the component profile being associated with a corresponding deployed component of the computing service, the deployed component being one of pre-defined and undefined;
constructing a computing service deployment plan, the computing service deployment plan being constructed based on information contained in the component profiles of the computing service; and
providing a discovering tool for manipulating the computing service deployment plan,
whereby when the deployed component is undefined and therefore undiscovered, the deployed component is discoverable by the method for constructing the computing service deployment plan.

### BRIEF DESCRIPTIONS OF THE DRAWING

Embodiments of the invention are described hereinafter with reference to the following drawing, in which:

FIG. 1 shows a block diagram representing a computing system deployment model;

FIG. 2 shows a block diagram of a layer of the computing system deployment model of FIG. 1 with a plurality of components contained therein being grouped in clusters;

FIG. 3 shows a block diagram of a component profiles of each component of FIG. 2;

FIG. 4 shows a process flowchart of discovery steps according to an embodiment of the invention;

FIG. 5 shows an overview of a working environment of the discovery steps of FIG. 4;

FIGS. 6 to 12 and 14 show examples of a user graphic interface of an apparatus for discovering and developing patterns according to an embodiment of the invention; and

FIG. 13 shows an example of a user interface for managing patterns in a pattern library according to an embodiment of the invention.

### DETAILED DESCRIPTION

An apparatus for discovering computing services architecture and developing patterns of computing services and method therefor are provided hereinafter.

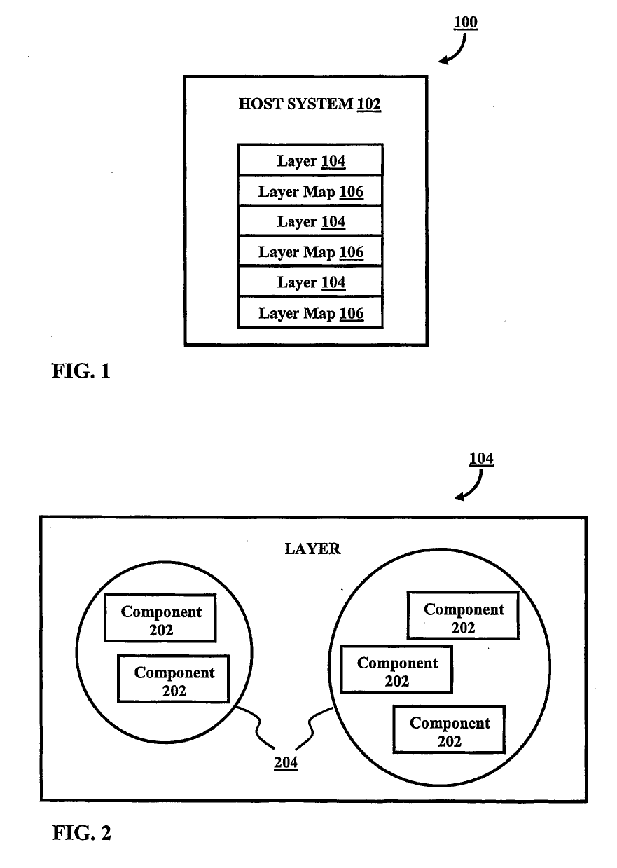

The apparatus for and method for discovering computing services architecture and developing patterns of computing services (hereinafter referred to as“the System”) according to an embodiment of the invention is described with reference to FIGS. 1 to 14. The System is preferably based on a computing system deployment model 100 as shown in FIG. 1.

The computing system deployment model 100 is for planning and realizing a deployment of a computing system (not shown) onto a computer-based host system 102, which typically comprises multiple geographically dispersed sub-systems. The computing system comprises multiple components 202 (shown in FIG. 2) residing within the host system 102. These components 202 are generally classified as service components, system components and resource components (all not shown in FIG. 1). These components 202 are organized into separate layers 104 within the host system 102. The layers 104 typically include a service layer, system layer and resource layer, which respectively contain service, system and resource components. Each layer 104 has an associated layer map 106. The layer map 106 of each layer 104 indicates the physical locality of a component 202 within the host system 102 and the association of another component 202 therewith.

The service components are for providing one or multiple application-specific, vendor-specific or domain-specific services, which include providing service-related contents such as web-contents and user account data.

The system components are conventionally known as server components and are for providing computing system-based resources and services to other components 202 within the host system 102. Examples of such system components are DNS servers, FTP servers, system libraries, Windows registries and key repositories.

The resource components represent one of a physical hardware that is associated with a computing node or a virtual device representing the physical hardware. Examples of hardware represented by the resource components include network cards, hard disks, routers, firewalls and memory modules.

The components 202 in each layer 104 are grouped into clusters 204 based on the functions thereof as shown in FIG. 2. Each cluster 204 contains at least one component 202. In the service layer, the service components are grouped into service clusters based on the similarity of services provided by each service component. Similarly, in the system layer, the system components are grouped into system clusters based on the function of each system component. Examples of system clusters include an operating system (OS) cluster, a database cluster and a virtual machine cluster. In the resource layer, the resource components are grouped into resource clusters based on the function of the resource component. For example, in the resource layer, there can be a network router cluster, a firewall cluster and a storage cluster.

Each cluster 204 has an associated cluster profile (not shown). The cluster profile contains a description of an associated cluster and a function descriptor describing the function of the components 202 contained therein.

Component Profile

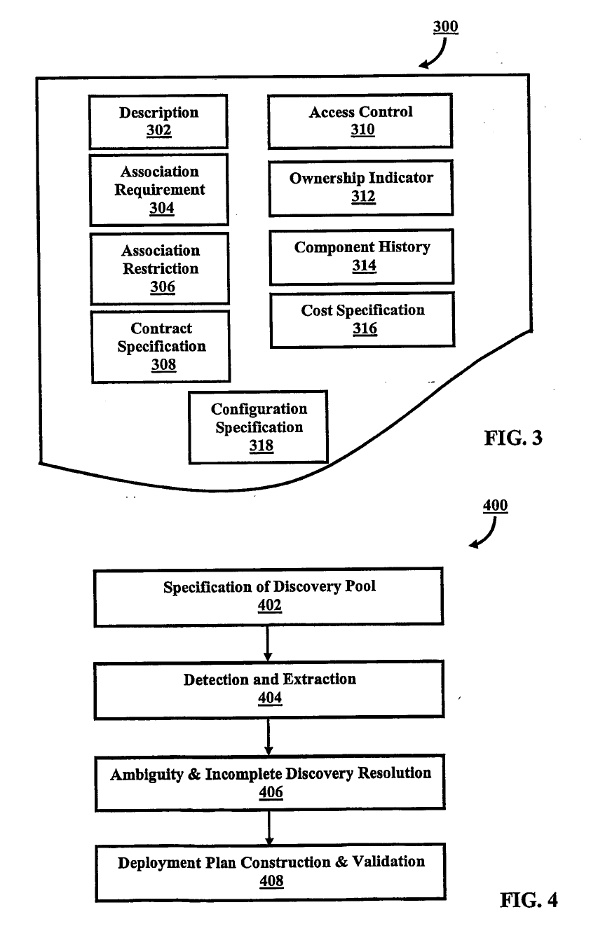

Each component 202 has a corresponding component profile 300 as shown in FIG. 3. The component profile 300 contains management information, which is used for planning the deployment of the component 202. The component profile 300 comprises a description 302 of the associated component 202, at least one association requirement 304, at least one association restriction 306, and at least one contract specification 308, a list of access controls 310, an ownership indicator 312, a component history 314, a list of cost specifications 316 and a configuration specification 318.

The association requirement 304 indicates which of the components 202 in the host system 102 are required for associating with the component being described by the component profile 300. For example, in the case of a service component, the component profile 300 is a service profile. Thus, the association requirement 304 indicates system components required for associating with the service component being described by the service profile.

The association restriction 306 indicates which of the components 202 in the host system 102 that are in conflict with and have been prohibited from accessing the component being described by the component profile 300. The association restriction 306 further provides information on potential and known conflicts. The information on the conflicts allows the conflicts to be properly managed or alleviated during the deployment of the computing system.

The contract specification 308 states the information to be provided by a corresponding component 202 for accessing the component 202 described by the component profile 300. An application of the contract specification is illustrated using a hypertext transfer protocol (HTTP) server (not shown) as follows. The system component of the HTTP server, for example an Apache HTTP server, requires a valid alias and a root directory location to be specified for access thereto. The valid alias and root directory location requirements are stated in the contract specification 308 of the system profile describing the system component of the Apache HTTP server. Therefore, a service component of an Enterprise server, for example, requiring access to the system component of the Apache HTTP server has to be provided with information required by the contract specification 308 thereof. The service component of the Enterprise server then provides the Apache HTTP server with the required valid alias and root directory location to the system component of the Apache HTTP server for access of the same thereby in accordance to the association requirements 304 of the service profile describing the service component.

The list of access controls 310 specifies the ability of a component 202 contained in another cluster 204, preferably from the same layer 104, to access the component 202 being described by the component profile 300 and vice-versa. The access controls 310 are conventionally provided by the vendors of the components 202 in the host system 102 to avoid association of components 202 supplied by one vendor from accessing or being accessed by components 202 supplied by another vendor. Further, the access controls 310 can be utilized for marketing, political, security or operational reasons.

The ownership history 312 indicates one or multiple owners of the component 202 described by the component profile 300 and the relative priority that each owner has over the component 202 based on the configuration of the deployment. The owner is one or more of any combination of a system including the host system 102, a cluster including the service, system and resource clusters, and a component 202 in the host system 102.

The component history 314 tracks the current and past configuration the component described by the component profile 300 is deployed upon. The component history 314 further reflects the dependency of other components 202 in the host system 102 on the component. The component history 314 is further used for restoring and archiving deployed computing systems. This enables any corruption to the computing system or the components therein to be rectified by enabling redeployment or restoration of the computing system to its most recent pre-corrupted state.

The list of cost specifications 316 specifies the corresponding cost of using of the component 202 being described by the component profile 300. The cost of using a component includes virtual memory usage (for example a random access memory or RAM), physical storage usage (for example a hard disk drive), the physical storage expansion requirements with respect to time and the like system resource requirements. The cost specifications 316 allows an administrator of a computing system to decide upon the viability of installing a component or a cluster of components while considering the current and future impact on system resource requirements if the component is installed.

The component configuration specification 318 specifies multiple configuration parameters for deploying the component. Each parameter is specified as a key-value pair, wherein the key refers to the parameter name, such as“application-name” and the value refers to as specific value corresponding to the parameter name, in this case, the specific application name, such as“oracle”. Another example of a key-pair is “server-port=80”. Other parameters include run-time information relating to how each component 202 is deployable and alterable parameters that affect the run-time behavior of the component 202. The run-time information includes installation paths, network ports and addresses, location of application-specific configuration files and logs, and the like component configuration details. The run-time information is one of application-specific, domain-specific and vendor-specific and ensures substantial accuracy in planning for the deployment of the computing system or the realization of the computing system infrastructure.

Discovery Steps

Using the framework of the component profile 300 described in the foregoing with reference to FIG. 3, computing services deployed in an existing computing system can be discovered by performing discovery steps 400 as shown in FIG. 4.

The operational principle behind the discovery steps 400 is based on the fact that most, if not all, component profiles of deployable components have a default or recommended configuration. Further, deployment of these components tends not to deviate too much from the recommended configuration and certain parameters used in the recommended configuration are also used or customized in the actual deployment.

However, it is unlikely that one vendor supplies all the deployed components. As such, information in the component profiles supplied by one vendor typically differs from information in the component profiles supplied by another vendor.

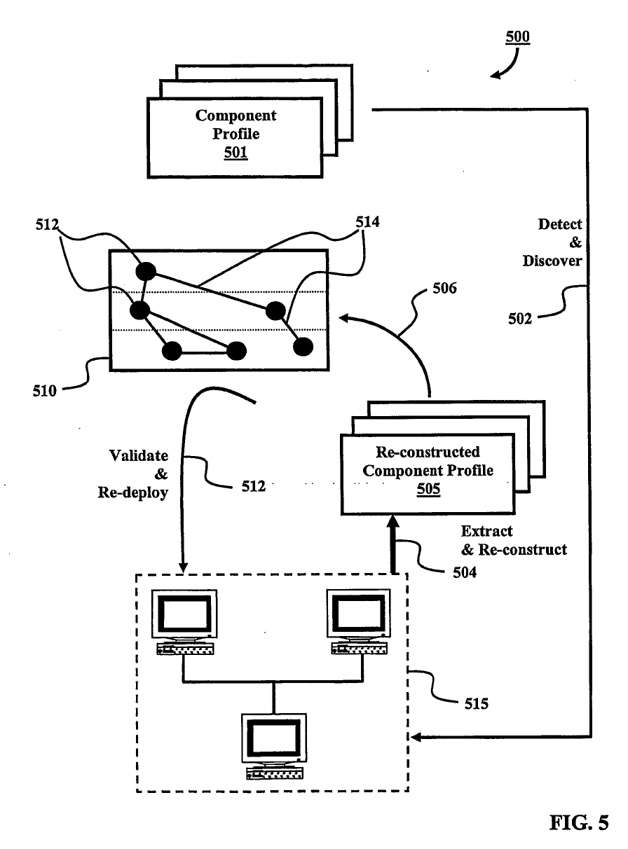

The discovery steps 400 seek to detect the presence of the deployed components and discover the properties (i.e. configuration and dependencies information) of the detected components and re-organize these discoveries into the framework of the component profile 300 for aiding the construction of a reusable deployment plan using the computing system deployment model 100 described in the foregoing. The operation of the discovery steps 400 is illustrated with reference to FIG. 5, which shows an overview of a working environment 500 for the discovery steps 400. The working environment 500 comprises a pool of component profiles 501, which are typically supplied by different vendors, a pool of re-constructed component profiles 505, a deployment plan 510 and an existing computing system 515. The objective of the discovery steps 400 is to discover and extract information to re-constructed the re-constructed component profiles 505, which are in the framework of component profile 300. Initially, the content of the re-constructed component profiles 505 is not known. Thus, the deployment plan 510, which comprises components 512 and dependencies 514 linking the components 512, are also not known. The components 512 typically comprise service, system and resource components, while the dependencies 514 are stipulated in the component profiles corresponding to each component 512. The content of the re-constructed component profiles 505 is embedded in the deployed components within the existing computing system 515 as stipulated in the component profile 501 supplied by different vendors. The deployed components need to be detected and the properties therein need to be discovered via a detection and discovery process 502. Once discovered, the configurations and dependencies information of the detected components are extracted 504 to reconstruct the re-constructed component profiles 505. Using the reconstructed component profiles 505, the deployment plan 510 of the deployed computer services is created 506. Thereafter, the constructed deployment plan 510 can be fine-tuned, validated, extended with new deployments and redeployed 512 to provide an improved and easy to manage computing system. The discovery steps 400 comprise a specification of discovery pool step 402, a detection and extraction step 404, an ambiguity and incomplete discovery resolution step 406 and a deployment plan construction and validation step 408 as shown in FIG. 4.

Specifying Discovery Pool

The specification of discovery pool step 402 is concerned with specifying or identifying a pool of component profiles for detecting the associated deployed components. Typically, these component profiles are provided by the vendors of the deployed components and contain default and/or recommended deployment parameters. The step 402 preferably involves performing one or more of the following tasks:
(a) Selecting one or more component profiles from a component profile library in the computing system.
(b) Selecting one or more component profile libraries from which component profiles are identified for including into the discovery pool.
(c) Creating new component profiles and discovery proxies for use in discovering the profiles of the deployed components, if component profiles of the deployed components are not readily available.
(d) Selecting one or more component profiles from any form of component profile repositories, for example, web-site repositories.

Each discovery proxy specifies either discovery-scripts for self-constructing (or self-discovering) the profile of a corresponding deployed component or a link to another component profile from which the properties therein can be inherited when re-constructing the profile of the corresponding deployed component. The information discovered by the discovery-scripts associated with the discovery proxy is compiled to provide a component profile, wherein the management information of the deployed component is arranged according to the framework of the component profile 300.

The discovery-scripts are platform-dependent or platform-independent scripts, which are executed during the detection and extraction step 404 as described hereinafter. Existing software reverse-engineering techniques such as source-code-level and binary-level analysis can be incorporated into the discovery scripts, depending on the granularity of extraction and level of understanding of the deployed components needed and difficulties in discovering the information. The discovery-scripts can also serve as additional discovery hints to enhance the detection and extraction process. Thus, component profiles can be tailored not just for planning and deployment but also for the discovery thereof. That is, the component profiles can be used as a means for specifying explicit instructions to drive and guide the detection and extraction process. Examples of the discovery-scripts include:
Component Detection discovery-script—used for detecting the presence of the deployed component;
Configuration Extraction discovery-script—used for extracting configuration information of the deployed component upon detection thereof;
Contract Extraction discovery-script—used for extracting dependencies and contract information of the deployed component upon detection thereof;
Self-construct discovery-script—used in self-constructing discovery proxies and when executed performs component detection, property extraction and completely re-constructs the component profile of the deployed component in accordance with the framework of the component profile 300; and
Service discovery-script—used for discovering complete services that may be composed of multiple deployed components, thus, performing multiple component discoveries.

In order to enhance the detection of component dependencies and conflicts, components that are specified in the association requirement and association restriction properties of each specified component profile may be automatically included into the discovery pool. However, the dependencies and mandatory contract specifications of the components automatically included into the discovery pool are preferably validated in this step 402 according to the contract specification 308 as defined in the component profile of each deployed component. Therefore, components that meet the association requirement but do not meet the contract specification are not included into the discovery pool.

Detecting and Extracting

Once the pool of component profiles is specified, the detection and extraction step 404 is initiated to search for the deployed components corresponding to the specified component profiles in the discovery pool and extract properties therefrom upon detecting the deployed components. The step 404 comprises three sub-steps:
(i) detecting the presence of deployed components;
(ii) extracting detected component configuration; and
(iii) determining detected component dependencies.

In the sub-step (i), a component corresponding to a specified component profiles in the discovery pool is deemed successfully detected if one or a combination of the following weighted parameters are detected in the file-system, system resources (such as network ports), system registries or other operating system dependent information source.

Base Directory Detection. A BasePath pathname attribute in the configuration property, which specifies the default base pathname location for the deployed component, matches fully or partially against pathnames that exist in the actual file-system. For partial matching, only the last element of the pathname is matched. The matching process is non-case sensitive and involves discarding any leading or ending non-alphabetical and white-space characters.

Configuration File Detection. A filename specified by a ConfigFile attribute in the configuration property matches fully or partially with one or more filenames that exist in the detected base directory or sub-directories thereof.

Error Log File Detection. A filename specified by an ErrorLog attribute in the configuration property matches fully or partially with one or more filenames that exist in the detected base directory or sub-directories thereof.

Log File Detection. A filename specified by a Log attribute in the configuration property matches fully or partially with one or more filenames that exist in the detected base directory or sub-directories thereof.

A Content Detection. One or more filenames or pathnames specified in the content property (not shown in FIG. 3) matches with one or more filenames that exist in the detected base directory or sub-directories thereof.

Component Name Detection. A Component Name attribute in the descriptor property matches a filename or directory name fully or partially in the existing file-system or a key in a system registry.

Vendor name Detection. A Component Vendor Name attribute in the descriptor property matches a filename or directory name fully or partially in the existing file-system or a key in a system registry.

Discovery-script Component Detection Test For discovery proxies or component profiles with discovery-scripts, executing the component detection discovery-scripts returns a COMPONENT_DETECTED or COMPONENT_NOT_DETECTED result.

Using a simple conditional probability, which measures the likelihood that a component is present, the final score of a component, after the performance of the sub-step (i), is given by:

$${\prod }_{i = 1}^{n} {p}_{i} \cdot {w}_{i}$$

where p represents the likelihood that a parameter is present, the value of p is between 0 and 1, with 1 indicating that the parameter is very likely to be present, w represents a weight associating with the parameter, the value of w is between 0 and 1, with 1 indicating that the parameter is very important, and n represents the number of parameters associated with one component.

Further, the foregoing detection conditions can be used to test for heuristics by using the association requirement and association restriction properties specified in the component profiles. These heuristics includes (a) Absence of Conflicts—no conflicting components detected and (b) Presence of Dependencies—detected presence of some or all dependant deployed components.

The outcome of the sub-step (i) is the successful detection of deployed components having corresponding component profiles as specified in the discovery pool. Further, any successfully detected conditional values or attributes are also updated into the appropriate properties and attributes of the corresponding component profiles. These updated component profiles are referred to as re-constructed component profiles. Information in each re-constructed component profile is arranged in a systematic and consistent manner in accordance with the component profile 300 framework described in the foregoing with reference to FIG. 3.

If the discovered attributes of the detected component fail to match with the attributes that are specified in the corresponding component profile, the detected component is tagged with an Identity-Incomplete status. If two or more detected components are found to match with one component profile specified in the discovery pool, each of these detected components is tagged with an Identity-Ambiguous status.

In the sub-step (ii), information relating to the configurations of the detected components are extracted and updated in the configuration property of the corresponding re-constructed component profiles. Attributes that are previously updated in the sub-step (i) are ignored. Incomplete and un-customized or default attributes are information that need to be extracted from the detected components.

For discovery proxies or component profiles with discovery-scripts, the extraction process is performed by executing the configuration extraction discovery-script therein. Otherwise, if configuration files are detected in the sub-step (i), partial matching of configuration keys is performed to deduce and extract the corresponding key values from the configuration files. This is achieved by performing string matching against the detected configuration files. This matching is also extended to the system registry, if one exists. If the component profile specifies only one default configuration set, which comprises multiple configuration key-value pairs of a component, in this case all the configuration key-value pairs, but multiple configuration sets are extracted from the detected component, the detected component is tagged with a Configuration-Ambiguous status. Thus, several possible configuration sets are generated for the user to choose from. However, if the extraction process fails to extract configuration keys specified in the component profile, the detected component is tagged with a Configuration-Incomplete status.

The outcome of the sub-step (ii) is the updated configuration information in the configuration property of the reconstructed component profiles of the detected deployed components. Further, each detected component is tagged with an appropriate status.

In the sub-step (iii), one or more detected components having dependency relationships detected in the sub-step (i) are verified to comply with mandatory dependency relationships specified in the requirement property of the corresponding component profiles. To determine if a dependency relationship of the one or more detected components is valid, contract information is extracted from the detected components and compared against contract information specified in the corresponding component profiles. If contract information cannot be extracted, the dependency relationship is deemed invalid.

For discovery proxies or component profiles with discovery-scripts, the contract extraction discovery-script is used for extracting contract information from the detected components. If there are no discovery-scripts and if configuration files are detected for the components having the same dependency relationship, partial matching of default and mandatory contract keys contained in the configuration files of the detected components is performed to deduce and extract common contract values that describe the dependency relationship. If a system registry exists, the matching process is also extended thereto. If the required dependency contract key and value cannot be determined, the dependency relationship is deemed invalid.

If one or more mandatory dependency relationships are not uniquely matched or validated, each of the corresponding detected components is tagged with a Dependency-Ambiguous status. If a complete match or one mandatory dependency relationship is not successfully verified, each of the corresponding detected components is tagged with a Dependency-Incomplete status.

The outcome of the sub-step (iii) is the confirmation of the dependency relationships between the detected components as specified in the corresponding component profiles.

Ambiguity and Incomplete Discovery Resolution

At the conclusion of steps 402 and 404, the properties of the deployed components are either completely discovered or partially discovered. The partially discovered components are tagged with one or a combination of Identity-Ambiguous, Identity-Incomplete, Configuration-Ambiguous, Configuration-Incomplete, Dependency-Ambiguous and Dependency-Incomplete statuses. These partially discovered components may be further fine-tuned in the step 406.

The step 406 requires user-assistance and preferably involves using the System according to an embodiment of the invention to help in resolving the ambiguity and incomplete discoveries. For the ambiguous discoveries, namely, the identity, configuration and dependency ambiguities, the user is required to select one of the detected alternatives for each of the ambiguities. For the incomplete discoveries, namely, the identity, configuration and dependency incompletes, the user is required to provide the incomplete parameters and attributes in the corresponding component profiles.

Deployment Plan Construction and Validation

In the step 408, a deployment plan is constructed from the re-constructed component profiles of the corresponding detected deployed components provided by the previous steps 402, 404 and 406. Further, the constructed deployment plan can be further refined and validated by using the System to provide a final deployment plan and patterns therefrom can be extracted and archived for future references.

The deployment plan is preferably graphically presented as nodes (each node represents a component) and dependency lines linking the nodes for indicating dependency relationships therebetween, like the exemplary deployment plan 505 shown in FIG. 5.

The step 408 also addresses over-detection and under-detection issues. Over-detection of deployed components, which is, partially addressed in the earlier steps where such components are tagged with ambiguous and/or incomplete statuses, arises from incorrect detection conditions or incorrect assignment of parameter weights. Thus, in the step 408, components that appear in the deployment plan but are not actually deployed in the computing system are removed or deleted from the deployment plan. The over-detection issue can be address by making the default detection conditions and weights dynamically adjustable or by having an adaptive or self-learning detection process. Alternatively, specific discovery-scripts are needed to accurately detect specific components.

Under-detection is typically detection misses that occur due to the following factors:
Deployed components having corresponding component profiles that are not specified in the discovery pool;
Deployed components having corresponding component profile that are specified in the discovery pool but the component profiles fails to provide sufficient hints for detecting the deployed components or the deployed components are heavily customized since the deployment thereof rendering the deployed components unrecognizable (i.e. cannot be generically detected); and
Deployed components do not have corresponding component profiles.

The first factor can be easily resolved by including the component profiles into the specified discovery pool. The second factor can be addressed by fine-tuning or relaxing the detection conditions and weights. Alternatively, discovery-scripts can be used to accurately detect the deployed components. The third factor can be addressed by creating a component profile for each of the detected components. Discovery proxy can be provided to automatically self-construct a component profile from the discoveries made by the execution of the discovery-scripts therein. Alternatively, a component profile can be recreated in a conventional manual way by describing the corresponding detected component and embedding hints therein for use during the detection and extraction process.

The System

Steps 406 and 408 preferably use the System according to an embodiment of the invention to help resolve the partially discovered components and to refine and validate the constructed deployment plan to provide a final deployment plan and patterns of the computing service.

The System allows the characteristics of the components of a computing service to be represented in a logical and easy to understand manner and provides editing tools for users to manipulate the properties and associations of the components. Further, the System enables patterns of deployment plan to be abstracted, analyzed and archived for future referencing. Thus, the System also provides tools for managing patterns of deployment plan and documentation.

The System comprises a graphical user interface (GUI) 600 as shown in FIG. 6. The GUI 600 comprises a visualizer window 602, an interaction mode controller 604, a minimum threshold controller 606 and an acceptable threshold controller 608 as shown in FIG. 6.

The deployment plan of a computing service is represented graphically in the visualizer window 602. Typically, each component 610 in the computing service is connected to another component 610 by a link 612 indicating a dependency relationship between the linked components 610. The arrowed end of the link 612 indicates the parent component and the non-arrow end of the link 612 indicates the child or dependent component. For example, as shown in FIG. 6, component A is dependent on components D and E to function properly. The deployment plan is constructed based on the latest information found in the component profile of each component 610, which is re-constructed based on information obtained from the detection and extraction process described in the foregoing. The information contained in the component profile comprises properties described in the foregoing with reference to FIG. 3 as well as the conditional probability accorded to the component as described in the foregoing.

Confidence Value and Confidence Difference Value

Each component 610 and link 612 of the deployment plan in the visualizer window 602 is annotated with a confidence value. The confidence value for each component 610 is derived from the detection probability of each component 610 and the confidence value for each link 612 is derived from dependency conditional probability of one component on another component. The conditional probabilities of each component 610 and link 612 are normalized to provide a confidence value between zero and 100 with the value 100 indicating that the component is discovered with 100 percent confidence.

The confident value assigned to each component 610 indicates the likelihood the component 610 is actually present in the computing system. For example, as shown in FIG. 6, components A, C and E have confidence values 95, 45 and 65, respectively. Thus, the likelihood of finding components A, C and B in the computing system are 95, 45 and 65 percent, respectively. The confidence value assigned to each link 612 indicates the likelihood the dependent component has a dependency on another component. For example, as shown in FIG. 6, the link 612 linking components A and E has a confidence value of 100 percent, which indicates that the likelihood of component A depends on component E is 100 percent.

Further, the components 610 and links 612 can be color coded to enhance understanding. The color given to each component 610 and link 612 is dependent on the confidence value thereof. For example, as shown in FIG. 6, component B can be presented in green color to indicate a high confidence value of 95, while component D can be presented in red color to indicate a low confidence value of 30. Similarly, the links 612 with high confidence values can be presented in green color, while the links with low confidence values can be presented in red color.

If the user sets a minimum threshold to 50, by using the minimum threshold controller 606, then components 610 and links 612 with confidence values lower than the minimum threshold are represented in red color indicating an unacceptable confidence level. The user can also set an acceptable threshold for all the components 610 and links 612 by using the acceptable controller 608. For example, as shown in FIG. 6, the acceptable threshold is set to 85. Thus, components 610 and links 612 with confidence values equal to or greater than the acceptable threshold are represented in green color indicating an acceptable confidence level. For components 610 and links 612 that have confidence values between the minimum threshold and acceptable threshold, colors, other than red and green, can be used to represent the components 610 and links 612 depending on the confidence values thereof.

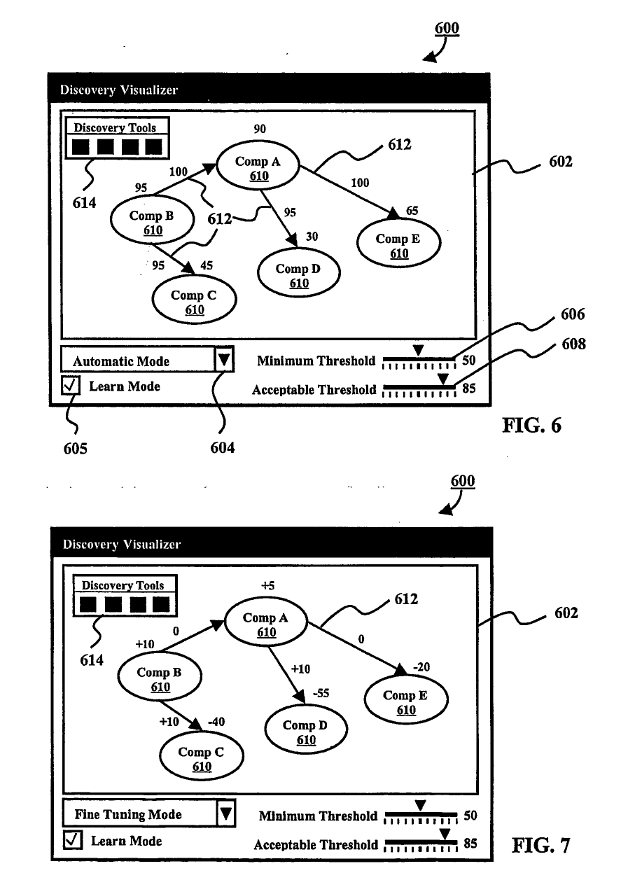

Alternatively, each component 610 and link 612 may be assigned a confidence difference value as shown in FIG. 7. The confidence difference value is the difference value between the acceptable threshold and the confidence value. For example, if the acceptable threshold is set at 85 and component A has a confidence value of 90, then the confidence difference value for component A is +5. Similarly, the confidence difference values for the remaining components 610 and links 612 can be calculated and displayed as shown in FIG. 7. For example, in FIG. 6, the confidence value of component C is 45. The corresponding confidence difference value of component C is −40, which is the difference between the acceptable threshold set by the user and the confidence value of component C as shown in FIG. 7.

The confidence difference value is a helpful indicator indicating to the user how far off the level of confidence of the components 610 and links 612 are from the acceptable level. Thus, the objective of the user is to manipulate the components 610 to arrive with components 610 and links 612 that have confidence difference values as close to zero as possible, and, preferably, greater than zero.

The GUI 600 provides three interaction modes for users to interact with the deployment plan in the visualizer window 602. These interaction modes include an Automatic Mode, a Fine Tuning Mode and a Manual Mode. In each interaction mode, the users are provided with editing tools for manipulating parameters associating with each component 610.

The Automatic Mode is preferably configured as a default mode. In this mode, each component 610 and link 612 in the deployment plan is displayed with a confidence value thereof as shown in FIG. 6. Further, manipulating the components 610 and links 612 are restricted. However, a user is permitted to adjust the thresholds 606 and 608.

In the Fine Tuning Mode, the user is given more access to fine tune critical parameters associating with each component 610 and link 612 to arrive at a higher level of confidence value. A single adjustment of a parameter of a selected component 610 results in the System inspecting and recalculating the confidence values of all components 610 and links 612 in the deployment plan. As such, this mode is preferably used by experience users. To further facilitate the adjustments, the confidence value of each component 610 and link 612 is displayed as confidence difference value as shown in FIG. 7.

The Manual Mode is similar to the Fine Tuning Mode except that the System only performs the inspection and recalculation of the confidence values upon the user instructing the System to do so. The reason behind this is to overcome certain functional impediments due to auto-adjustment of the confidence values upon every adjustment to a parameter of a component 610. This mode of interaction is preferred for situations where many manipulations are required and the user prefers to carry out all the manipulations before instructing the System to re-inspect and recalculate the confidence values of the modified deployment plan. A further advantage of this mode over

The GUI 600 also provides a Learning Mode, which operates in conjunction with the above three described interaction modes. The Learning Mode can be activated by simply checking a learn mode box 605. Once activated, the Learning Mode captures known heuristics. These heuristics may include the type of component that works well with another. For example, through the adjustments made to the components 610, the user may arrive at the knowledge that certain databases work very well with certain application servers. Thus, this knowledge may be captured as a pattern that can be used for future deployment plans. Alternatively, if it is established that a database component does not work well with an application server as reflected by the low confidence value, this knowledge may also be captured as anti-pattern. These heuristics may be deposited in a knowledge management framework for future reference. Based on these heuristics, for example, the probability of an application server is present in a computing system can be deduced based on the knowledge that an associated database component, as per the reference pattern, is present in the computing system.

The Automatic Mode, Fine Tuning Mode and Manual Mode can be selected by using the interaction mode controller 604.

The System further comprises editing tools such as discovery tools, pattern tools and learning tools.

Discovery Tools

Discovery tools are provided for manipulating components 610 and links 612 (dependency relationships) between the components 610 in a deployment plan to provide confidence values for the components 610 and links 612 as close to 100 as possible. Manipulating a component involves associating the component with a corresponding component profile from a component profile library, adjusting component dependencies, or modifying the confidence value of the component. Examples of the discovery tools include tool for single component focus; tool for single dependency focus; tool for single component-single dependency focus and tool for single component-multiple dependency focus. Each of these tools can be activated by clicking a button on a floating toolbar 610, as shown in FIG. 6.

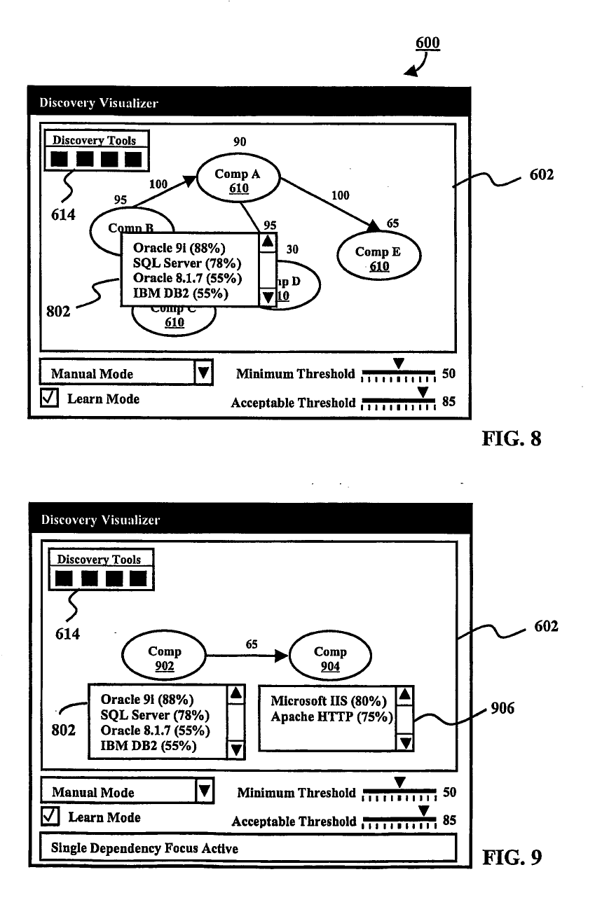

The single component focus tool allows a user to focus on one detected component at a time. The user can manipulate the detected component by performing a text-based association or by providing a ranking of possible component profiles based on the confidence values. For example, as shown in FIG. 8, a list of possible component profiles 802 is provided when the user presses the right mouse button while the mouse cursor is over a component 610. The user can choose the most suitable component profile for associating with a component 610. Once a choice is made, the System automatically calculates new confidence values (if operating in the Fine Tuning Mode) and displays the confidence difference values for all the components 610 and links 612 in the deployment plan.

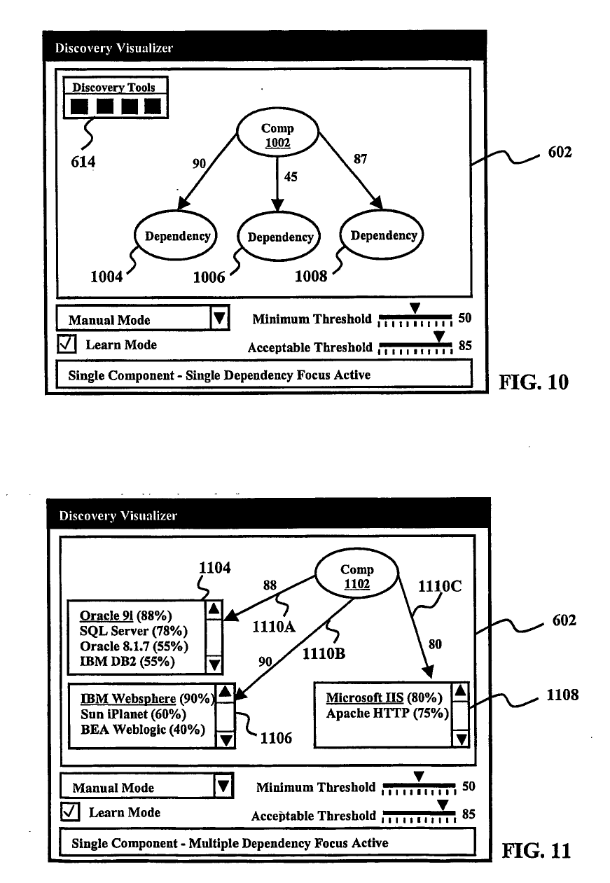

The user can also force change the confidence value of a component if the user is certain that the detected component is the correct component. For example, if steps 402 and 404 described in the foregoing detect a component with a confidence value of 60, but the user is certain that correct component is detected, the user can force change the confidence value to 100 to compensate for the inadequate discovery. Further, in the cases where it is obvious to the user, a relationship between two components 610 can be force changed by the user. This is achieved by having the user clicking on one end of a link 612 connecting the two components 610 in the visualizer window 602 and dragging selected end of the link 612 to another component 610 to establish a new relationship thereto. The single dependency focus tool allows a user to focus on one dependency at a time. This tool is used for improving the dependency confidence level by changing the components 902 and 904 as shown in FIG. 9. Since the user is only interested in the relationship between components 902 and 904, the user is presented with component lists 802 and 906 for components 902 and 904, respectively. Each component in the lists 802 and 906 is provided with a confidence value. If the user selects Oracle 9i for component 902, the System recalculates the confidence value for component 904. In addition, the confidence value of each component in the list 906 is recalculated in response to the selection of Oracle 9i. Similarly, if the user selects Apache HTTP for component 904, the System recalculates the confidence values for component 902 and the components in the list 802. Based on the selected component, the dependency confidence level is changed according. The single component-single dependency focus tool allows a user to find the best option available for a single dependency. For example, as shown in FIG. 10, if the focus is on a component 1002, all parent components (1004, 1006 and 1008) that the component 1002 depends on are provided in the visualizer window 602. Thus, all that is required of the user is to select the dependency component that provides the highest level of dependency confidence value. In the example, component 1004 provides the highest level of dependency confidence value.

The single component-multiple dependency focus tool allows a user to manipulate a detected single component 1102 having multiple dependency relationships (links 1110A-C) as shown in FIG. 11. For each dependency relationship, there is provided a list of components with confidence values from which the user can choose to confirm the dependency relationship with component 1102. For example, for dependency relationship link 1110A, a component list 1104 containing four components with different confidence values is provided. The selected component is underlined, or alternatively, can be presented using a color, preferably, green. Components with confidence values below the minimum threshold can be presented using a color, preferably, red. Similarly, for dependency relationship links 1110B-C, component lists 1106 and 1108 are provided.

Pattern Tools

Pattern tools are provided for users to create and define patterns. A pattern is created when multiple components are grouped together. The grouping process involves registering the components and the dependency relationships between the components within the group. The created pattern may have dependency relationships with external components that are not part of the created pattern. Further, links and references to other patterns can also be specified as part of the created pattern. The user may also be prompted to provide information relating to how, when and where the created-pattern is preferably usable.

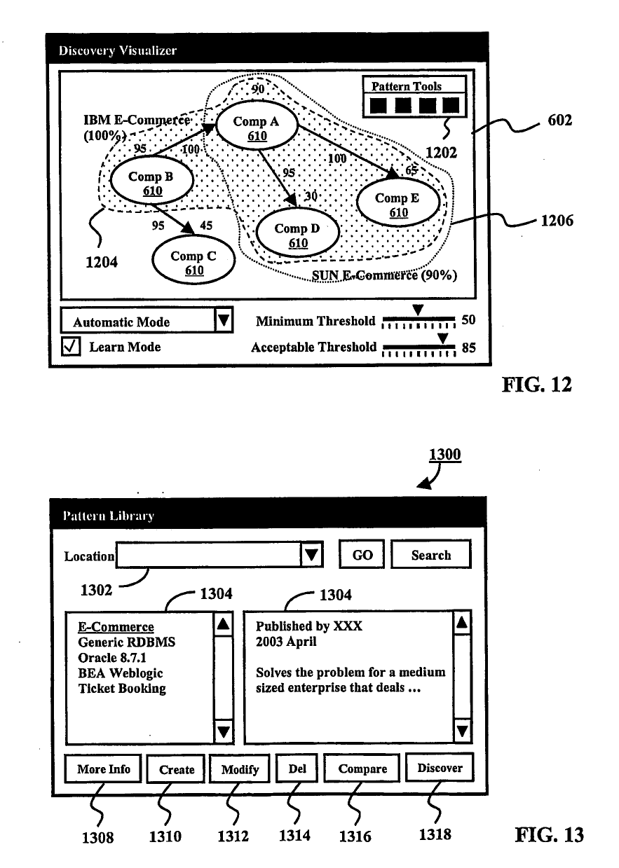

A pattern is defined by using either a text-based approach or a graphic-based approach. The graphic-based approach is illustrated in FIG. 12, where a boundary is drawn around components identified for including into a pattern. A pattern floating toolbar 1202 containing various tools is provided. One such tool is a selection pen tool. Using the selection pen tool, the user can draw a boundary on the visualizer window 602 for grouping components that constitutes a pattern. Examples of patterns created using the selection pen tool are patterns 1204 and 1206, as shown in FIG. 12. The patterns can be created at varying granularities based on the importance of the patterns. For example, a pattern can be defined for a service such as an e-Store service. The e-Store service provides details such as the components that should be present and how these components should be configured together to satisfy the business requirements. On the other hand, a pattern can be defined to specify how a single component is to be deployed. For example, a pattern may suggests that a component Oracle is to be deployed in such a way that the transaction server is found in one computing system while a database is setup in another computing system.

Once a pattern is created, the pattern can be archived in a pattern library for future references. The pattern can be used as template, which indicates a best practice or bad practice. Bad practice template (or anti-pattern) should be avoided even though the pattern solves a problem. This identification process can be performed either manually or automatically. The user can manually tag a pattern as a good pattern or a bad one based on the experience of the user. Alternatively, pattern-matching techniques can be employed to match an identified pattern against a list of known good or bad patterns to provide a score of how good or bad a pattern is.

Each pattern can also be assigned a unique signature. The unique signature is generated by using a hashing scheme, which processes information contained in the component profiles of the components in the pattern. Accordingly, once a component in the pattern is changed or modified, the unique signature for the pattern also changes. Thus, the unique signature can also be used as an index for searching purposes.

The System preferably provides a user interface 1300 for managing or documenting patterns in the pattern library, as shown in FIG. 13. The user interface 1300 comprises a pattern location box 1302 for indicating the location of a pattern repository, a patterns window 1304 for displaying the patterns in the specified pattern repository and a pattern description window 1306, which provides brief information on a selected pattern.

The user interface 1300 further comprises a More Info button 1308 for providing extra information on a selected pattern, a Create button 1310, a Modify button 1312, a Delete button 1314, a Compare button 1316 and a Discover button 1318, as shown in FIG. 13.

The buttons 1310, 1312, 1314 and 1316 allow a user to create, modify, delete and compare patterns in the patterns window 1304, respectively. The Discover button 1318 allows the user to either start a fresh discovery process based on a selected pattern or search for a selected pattern in a computing system. This discovery process is also known as a pattern based discovery process.

The pattern based discovery process allows a user to search for matching patterns in the Internet or extracting patterns from an identified computing system. The pattern extracting process involves analyzing the identified computing system for patterns and comparing the patterns against patterns in a pattern library. If a match is found, either partially or fully, the patterns extracted are displayed in the visualizer window 602, where components that constitute a matched pattern are preferably highlighted in the same color. Further, the user is able to mark each pattern extracted as correct, acceptable or anti-pattern, which is then archived for future use.

Each pattern can also be assigned a weight, similar to the weights assigned to the properties in a component profile as described in the foregoing. The pattern weight is a useful indicator when comparing an infrastructure against a partial pattern, which is a subset of a complete pattern. For example, as shown in FIG. 12, a complete pattern is displayed in the visualizer window 602. Within the complete pattern, two partial patterns 1204 and 1206 are defined. Comparing an infrastructure against these partial patterns 1204 and 1206 yields weights, which are converted into confidence values of 100 and 90, respectively, as shown in FIG. 12. Based on the confidence value, the user manipulates the partial patterns 1204 and 1206 to provide as high a confidence value as possible for the partial patterns 1204 and 1206.

Tools are also provided for comparing one pattern against another to derive a super-pattern, which is typically a merger of two or more individual patterns together. For example, if a user observes two patterns consistently deployed on the same computing system, the user may combine the two patterns together to provide one super-pattern. The pattern comparing process involves superimposing one pattern on another. Once the overlaying association is established, the System compares the differences between the overlaying patterns and provides an indicator, preferably similar to the confidence value or confidence difference value, for indicating the level of matching accuracy. The higher the level of matching is, the closer a pattern is to a known pattern.

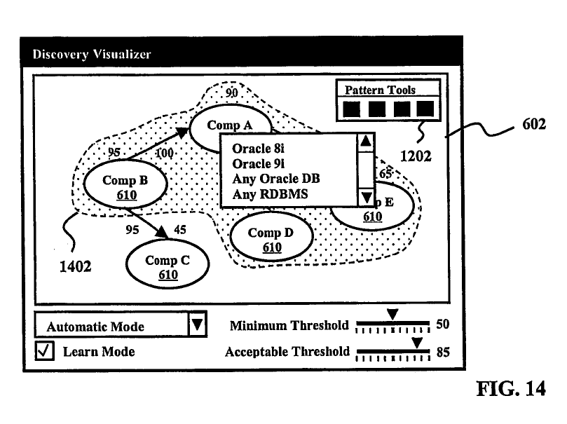

A strategy-to-pattern approach is another way for creating patterns. Strategies are often associated with computing service deployment process. Thus, strategies typically comprise specific deployable components as well as actual deployment options such as configuration information and specific products to be used. Using a strategy as a starting point, patterns can be created by modifying the specific deployable components in the strategy to a generic component. For example, FIG. 14 shows a graphical representation of a strategy in the visualizer window 602. A pattern 1402 can be defined by using the selection pen tool from the pattern floating toolbar 1202 to draw a pattern boundary enclosing multiple components 610 as shown. If the strategy is to use Oracle 8i database and if the user is certain that any Oracle database works equally well, then the user may select Any Oracle DB as a new (generic) component for the pattern. Once the components enclosed in the pattern boundary are confirmed, the pattern 1402 is deemed created. The pattern 1402 can then be archived for future references.

Learning Tools

The System also provides learning tools that are similar to macro recorders, which record the user's interaction in the visualizer window 602. The recorded interaction may be supplemented with additional information manually provided by the user. The recorded interaction is archived as an activity that can be invoked by the user to repeat the activity, thus, enhancing the productivity of using the System.

In the foregoing manner, an apparatus for discovering and developing patterns of a computing service and method therefor are described according to an embodiment of the invention for addressing one or more of the foregoing disadvantages of conventional methods and tools. It will be apparent to one skilled in the art in view of this disclosure that numerous changes, modifications and combinations can be made without departing from the scope and spirit of the invention.

1. An apparatus for discovering computing services architecture and developing patterns of computing services, the apparatus comprising:
a component profile repository for containing component profiles of a computing service, each component profile being associated with and being descriptive of a corresponding deployable component, at least one of the component profiles being associated with a corresponding deployed component of the computing service, the deployed component being one of pre-defined and undefined;
a computing service deployment plan, the computing service deployment plan being constructed based on information contained in the component profiles of the computing service; and
a discovering tool for manipulating the computing service deployment plan, whereby when the deployed component is undefined and therefore undiscovered, the deployed component is discoverable by the apparatus for constructing the computing service deployment plan.

2. The apparatus as in claim 1, wherein each component profile comprises multiple properties, each property being one of:
a description of the component;
a configuration specification;
at least one association requirement;
at least one association restriction; and
at least one contract specification, each contract specification specifying at least one parameter required from another component for associating thereto.

3. The apparatus as in claim 1, wherein the computing service deployment plan is represented by a plurality of nodes and link, each node is associated with a deployed component and each link linking one node to another node for establishing a dependency relationship thereto.

4. The apparatus as in claim 3, wherein each node and link is annotated with a component confidence value and a dependency confidence value respectively, the component confidence value being indicative of the likelihood a component associated with the node being present in a computing system, the dependency confidence value being indicative of the likelihood of a component has a dependency relationship on another component, the component and dependency confidence values being calculated based on the respective detection probability and dependency probability of a component associated with the node.

5. The apparatus as in claim 3, wherein the discovering tool comprises means for changing a dependency relationship of a first component on a second component to a third component thereby establishing a new dependency relationship of the first component on the third component in the computing service deployment plan.

6. The apparatus as in claim 4, wherein the discovering tool comprises a minimum confidence value threshold controller for setting a minimum confidence value threshold.

7. The apparatus as in claim 6, wherein the each node and link having the respective component and dependency confidence values lower than the minimum confidence value threshold are represented using a color.

8. The apparatus as in claim 4, wherein the discovering tool comprises an acceptable confidence value threshold controller for setting an acceptable confidence value threshold.

9. The apparatus as in claim 8, wherein each node and link having the respective component and dependency confidence values equal to or higher than the acceptable confidence value threshold are represented using a color.

10. The apparatus as in claim 4, wherein the discovering tool comprises means for changing the component confidence value of a node.

11. The apparatus as in claim 4, wherein the discovering tool comprises means for performing component and dependency confidence values recalculation upon detecting a change in the information contained in a component profile of a corresponding component in the computing service deployment plan.

12. The apparatus as in claim 1, wherein the discovering tool comprises means for replacing the component profile of one component in the computing service deployment plan with a different component profile.

13. The apparatus as in claim 1, wherein the discovering tool being operable in multiple interaction modes for providing different levels of capability for manipulating and re-constructing the computing service deployment plan, each interaction mode being one of automatic mode, fine tuning mode and manual mode.

14. The apparatus as in claim 1, further comprising a learning tool for capturing and repeating a sequence of computing service deployment plan manipulating steps using the discovering tool thereby enhancing productivity.

15. The apparatus as in claim 1, further comprising a pattern tool for creating and managing a pattern, the pattern comprising at least one deployable component.

16. The apparatus as in claim 15, wherein the pattern tool comprises a selection pen for identifying at least one computing service component for defining a pattern, the selection pen being a virtue selection tool.

17. The apparatus as in claim 15, wherein the pattern tool comprises means for acquiring information relating to how, when and where a pattern is usable upon defining the pattern.

18. The apparatus as in claim 15, wherein the pattern tool comprises means for tagging a pattern with a status upon defining the pattern, the status being one of a good pattern and a bad or anti-pattern.

19. The apparatus as in claim 15, wherein the pattern tool comprises means for assigning a pattern a unique signature, the unique signature being generated using a hashing scheme which processes information contained in the at least one component profile corresponding to the at least one deployable component in the pattern.

20. The apparatus as in claim 19, wherein the unique signature of the pattern is used as an index for searching purposes.

21. The apparatus as claim 15, wherein the pattern tool comprises means for archiving a pattern upon defining the pattern and retrieving the pattern.

22. The apparatus as in claim 15, wherein the pattern tool comprises a user interface for patterns in a pattern library, the user interface comprising:
means for locating the pattern library;
means for displaying patterns contained in the pattern library; and
means for displaying information relating to a selected pattern.

23. The apparats as in claim 15, wherein the pattern tool comprises means for deleting a selected pattern.

24. The apparatus as in claim 15, wherein the pattern tool comprises means for comparing at least two selected patterns.

25. The apparatus as in claim 15, the pattern tool comprises means for discovering a pat the means for discovering the pattern being one of a tool for starting a component discovery process based on a selected pattern and a tool for searching for a selected pattern in a computing system.

26. The apparatus as in claim 15, further comprising a graphical user interface for interfacing a user with the computing service, deployment plan, the discovering tool and the pattern tool.

27. A method of discovering computing services architecture and developing patterns of computing services, the method comprising the steps of:
providing a component profile repository for containing component profiles of a computing service, each component profile being associated with and being descriptive of a corresponding deployable component, at least one of the component profile being associated with a corresponding deployed component of a the computing service, the deployed component being one of predefined and undefined;
constructing a computing service deployment plan, the computing service deployment plan being conducted based on information contained in the component profiles of the computing service; and
providing a discovering tool for manipulating the computing service deployment plan, whereby when the deployed component is undefined and therefore undiscovered, the deployed component is discoverable by the method for constructing the computing service deployment plan.

28. The method as in claim 27, wherein the step of constructing the computing service deployment plan comprises the step of representing the computing service deployment plan using a plurality of nodes and links, each node is associated with a deployed component and each link linking one node to another node for establishing a dependency relationship thereto.

29. The method as in claim 28, wherein the step of constructing the computing services deployment plan further comprising the step of annotating each node and link with a component confidence value and a dependency confidence value respectively, the component confidence value being indicative of the likelihood a component associated with the node being present in a computing system, the dependency confidence value being indicative of the likelihood of a component has a dependency relationship on another component the component and dependency confidence values being calculated based on the respective detection probability and dependency probability of a component associated with the node.

30. The method as in claim 28, wherein the step of providing the discovering tool comprises the step of providing a tool for changing a dependency relationship of a first component on a second component to a third component thereby establishing a new dependency relationship of the first component on the third component in the computing service deployment plan.

31. The method as in claim 29, wherein the step of providing the discovering tool comprises the step of providing a minimum confidence value threshold controller for setting a minimum confidence value threshold.

32. The method as in claim 31, wherein the step of constructing the computing services deployment plan further comprising the step of representing each node and link having the respective component and dependency confidence values lower than the minimum confidence value threshold in a color.

33. The method as in claim 29, wherein the step of providing the discovering tool comprises the step of providing an acceptable confidence value threshold controller for setting an acceptable confidence value threshold.

34. The method as in claim 33, wherein the step of constructing the computing services deployment plan further comprising the step of representing each node and link having the respective component and dependency confidence values equal to or higher than the acceptable confidence value threshold in a color.

35. The method as in claim 29, wherein the step of providing the discovering tool comprises the step of providing a tool for changing the component confidence value of a node.

36. The method as in claim 29, wherein the step of providing the discovering tool comprises the step of providing a tool for performing component and dependency confidence values recalculation upon detecting a change in the information contained in a component profile of a corresponding component in the computing service deployment plan.

37. The method as in claim 27, wherein the step of providing the discovering tool comprises the step of providing a tool for replacing the component profile of one component in the computing service deployment plan with a different component profile.

38. The method as in claim 27, wherein the step of providing the discovering tool comprises the step of providing multiple interaction modes for providing different levels of capability for manipulating and re-constructing the computing service deployment plan, each interaction mode being one of automatic mode, fine tuning mode and manual mode.

39. The method as in claim 27, further comprising the step of providing a learning tool for capturing and repeating a sequence of computing service deployment plan manipulating steps using the discovering tool thereby enhancing productivity.

40. The method as in claim 27, further comprising a step of providing a pattern tool for creating and managing a pattern, the pattern comprising at least one deployable component.

41. The method as in claim 40, wherein the step of providing the pattern tool comprises the step of providing a selection pen for identifying at least one computing service component for defining a pattern, the selection pen being a virtue selection tool.

42. The method as in claim 40, wherein the step of providing the pattern tool comprises the step of providing a tool for acquiring information relating to how, when and where a pattern is usable upon defining the pattern.

43. The method as in claim 40, wherein the step of providing the pattern tool comprises the step of providing a tool for tagging a pattern with a status upon defining the pattern, the status being one of a good pattern and a bad or anti-pattern.

44. The method as in claim 40, wherein the step of providing the pattern tool comprises the step of providing a hashing scheme for generating a unique signature for assigning to a pattern, the hashing scheme generates the unique signature by processing information contained in the component profile corresponding to the at least one deployable component in the pattern.

45. The method as in claim 40, wherein the step of providing the pattern tool comprises the step of providing tools for archiving a pattern upon defining the pattern and retrieving the pattern.

46. The method as in claim 40, wherein the step of providing the pattern tool comprises the step of providing a user interface for managing patterns in a pattern library, the user interface comprising:
means for locating the pattern library;
means for displaying patterns contained in the pattern library; and
means for displaying information relating to a selected pattern.

47. The method as in claim 40, wherein the step of providing the pattern tool comprises the step of providing a tool for deleting a selected pattern.

48. The method as in claim 40, wherein the step of providing the pattern tool comprises the step of providing a tool for comparing at least two selected patterns.

49. The method as in claim 40, wherein the step of providing the pattern tool comprises the step of providing a tool for discovering a pattern, the tool for discovering the pattern being one of a tool for starting a component discovery process based on a selected pattern and a tool for searching for a selected pattern in a computing system.

50. The method as in claim 40, further comprising a step of providing a graphical user interface for interfacing a user with the computing service deployment plan, the discovering tool and the pattern tool.
